(19) United States
(12) Patent Application Publication
(10) Pub. No.: US 2026/0038708 A1
(43) Pub. Date: Feb. 5, 2026

(54) RECTANGULAR WIRE AND PRODUCTION METHOD FOR SAME

(71) Applicant: AGC Inc., Tokyo (JP)

(72) Inventors: Masatoshi ABE, Tokyo (JP); Toru SASAKI, Tokyo (JP)

(73) Assignee: AGC Inc., Tokyo (JP)

(21) Appl. No.: 19/353,780

(22) Filed: Oct. 9, 2025

Related U.S. Application Data
(63) Continuation of application No. PCT/JP2024/014830, filed on Apr. 12, 2024.

(30) Foreign Application Priority Data
Apr. 12, 2023 (JP) 2023-064887

(51) Int. Cl. H01B 3/30; H01B 7/02; H01B 13/14

(52) U.S. Cl. CPC H01B 3/307; H01B 7/02; H01B 13/14

(57) ABSTRACT

The present invention pertains to a rectangular wire including:
a rectangular conductor; and
a film of an insulating coating material formed by extrusion molding that directly covers the entire circumferential direction of the rectangular conductor,
wherein: a melt flow rate of the insulating coating material at 372° C. is from 13 to 300 g/10 min;
an average thickness of the film of the insulating coating material is from 10 to 1,000 μm;
an unbiased standard deviation of the thickness of the film of the insulating coating material in the axial direction of the rectangular wire is less than 0.06 mm;
the insulating coating material contains a fluorine-containing copolymer having a unit based on tetrafluoroethylene and a unit based on perfluoroalkyl vinyl ether; and
the rectangular wire is such that the film of the insulating coating material does not peel off from the rectangular conductor in a winding test conforming to “JIS3216-3:2011 5.1.2 Rectangular Wire”.

This application is a continuation application of International Application No. PCT/JP2024/014830, filed on Apr. 12, 2024, which claims the benefit of priority of the prior Japanese Patent Application No. 2023-064887, filed Apr. 12, 2023 in Japan, the contents of which are incorporated herein by reference.

### BACKGROUND OF THE INVENTION

### Field of the Invention

The present invention relates to a rectangular wire and a production method of the same.

### Description of Related Art

Vehicle equipment or the like used in automobiles, railroads, aircraft, and the like is desired to be smaller and lighter. Therefore, a film of an insulating coating material of an insulated electric wire of an electrical equipment used in the vehicle equipment is required to be thinner. Furthermore, with the increase in the output and voltage of electrical equipment, the above insulating coating material is required to have excellent insulation properties as well as strong adhesion to a conductor.

By employing a rectangular conductor as a conductor of an electric wire, the space factor is higher when it is coiled, as compared to a round wire. As a result, it is possible to save space in the entire coil, which contributes to the miniaturization of electrical equipment. However, in the case of rectangular conductors, it is more difficult to form a uniform film of an insulating coating material compared to round wires, and there is a problem in that the insulation properties cannot be sufficiently maintained.

Patent Document 1 discloses a method for producing a rectangular wire in which a powder having an average particle size of 0.02 μm or more and 150 μm or less and containing a melt-moldable fluororesin with a melting point of 100° C. or higher and 325° C. or lower and at least one functional group selected from the group consisting of a carbonyl group-containing group, a hydroxy group, an epoxy group, and an isocyanate group is coated onto a rectangular conductor, thereby forming a film of an insulating coating layer with a thickness of 10 to 150 μm on the outer periphery of the rectangular conductor.

### PRIOR ART DOCUMENTS

### Patent Document

[Patent Document 1] Japanese Unexamined Patent Application, First Publication No. 2017-204410

### SUMMARY OF THE INVENTION

### Problems to be Solved by the Invention

However, the production method described in Patent Document 1 requires a powder preparation step and a firing step after the powder coating, which results in a problem of low productivity. In addition, since the powder is coated, there is a problem of low surface smoothness of the film of the insulating coating material. Furthermore, the film of the insulating coating material exhibits low conformability with respect to the rectangular conductor, and during bending deformation of the rectangular wire, there are also problems of wrinkles forming in the film of the insulating coating material or the film of the insulating coating material peeling off from the rectangular conductor.

The present invention has an object of providing: a rectangular wire that is highly productive and exhibits excellent surface smoothness of the film of the insulating coating material and conformability of the film of the insulating coating material with respect to the rectangular conductor during bending deformation; as well as a production method thereof.

### Means for Solving the Problem

The present invention includes the following aspects.

[1] A rectangular wire including: a rectangular conductor having a rectangular cross section in a direction perpendicular to the axial direction; and a film of an insulating coating material formed by extrusion molding that directly covers the entire circumferential direction of the aforementioned rectangular conductor, wherein a melt flow rate of the aforementioned insulating coating material at 372° C. is from 13 to 300 g/10 min, an average thickness of the film of the aforementioned insulating coating material is from 10 to 1,000 μm, an unbiased standard deviation of a thickness of the film of the aforementioned insulating coating material in the axial direction of the aforementioned rectangular wire is less than 0.06 mm, the aforementioned insulating coating material contains a fluorine-containing copolymer having a unit based on tetrafluoroethylene and a unit based on perfluoroalkyl vinyl ether, and the aforementioned rectangular wire is such that the film of the aforementioned insulating coating material does not peel off from the aforementioned rectangular conductor in a winding test conforming to “JIS3216-3:2011 5.1.2 Rectangular Wire”.

[2] The rectangular wire according to [1], wherein a cross sectional area of the aforementioned rectangular conductor is 2.6 mm² or more.

[3] The rectangular wire according to [1] or [2], wherein the aforementioned fluorine-containing copolymer has a —CH₂OH group, and an amount of the aforementioned —CH₂OH group is more than 30 with respect to 1×10⁶ main chain carbon atoms of the aforementioned fluorine-containing copolymer.

[4] The rectangular wire according to any one of [1] to [3], wherein when the aforementioned fluorine-containing copolymer is molded into a test piece having a thickness of 4 mm, a ratio of a flexural modulus FM_{B} of the aforementioned test piece and a flexural modulus FM_{A} of a heated test piece obtained after heating the aforementioned test piece at 275° C. for 96 hours (FM_{A}/FM_{B}) is 1.2 or more.

[5] The rectangular wire according to any one of [1] to [4], wherein a partial discharge inception voltage of the aforementioned insulating coating material is 800 Vrms or more.

[6] A method for producing a rectangular wire including a rectangular conductor having a rectangular cross section in a direction perpendicular to the axial direction, and a film of an insulating coating material formed by extrusion molding that directly covers the entire circumferential direction of the aforementioned rectangular conductor, the method including: melting a fluorine-containing copolymer using an extruder equipped with a die; and extruding a melted fluorine-containing copolymer from the aforementioned die around the aforementioned rectangular conductor; thereby coating around the aforementioned rectangular conductor with the aforementioned melted fluorine-containing copolymer and forming the aforementioned insulating coating material; wherein a melt flow rate of the aforementioned insulating coating material at 372° C. is from 13 to 300 g/10 min, an average thickness of the film of the aforementioned insulating coating material is from 10 to 1,000 μm, an unbiased standard deviation of a thickness of the film of the aforementioned insulating coating material in the axial direction of the aforementioned rectangular wire is less than 0.06 mm, the aforementioned fluorine-containing copolymer has a unit based on tetrafluoroethylene and a unit based on perfluoroalkyl vinyl ether, and the aforementioned rectangular wire is such that the film of the aforementioned insulating coating material does not peel off from the aforementioned rectangular conductor in a winding test conforming to “JIS3216-3:2011 5.1.2 Rectangular Wire”.

[7] The method for producing a rectangular wire according to [6], wherein a drawdown ratio DDR calculated by the following Formula 1 is 0.5 or more and less than 10.0.

$$DDR = ( {D}_{A} - {C}_{A} ) / ( {F}_{A} - {C}_{A} ) \qquad Formula 1$$

In the aforementioned Formula 1, D_{A} is an opening area (mm²) of the aforementioned die, C_{A} is a cross sectional area (mm²) of the aforementioned rectangular conductor in a direction perpendicular to the axial direction, and F_{A} is a cross sectional area (mm²) of the aforementioned rectangular wire in a direction perpendicular to the axial direction.

[8] The method for producing a rectangular wire according to [6] or [7], wherein a cross sectional area of the aforementioned rectangular conductor is 2.6 mm² or more.

[9] The method for producing a rectangular wire according to any one of [6] to [8], wherein the aforementioned fluorine-containing copolymer has a —CH₂OH group, and an amount of the aforementioned —CH₂OH group is more than 30 with respect to 1×10⁶ main chain carbon atoms of the aforementioned fluorine-containing copolymer.

[10] The method for producing a rectangular wire according to any one of [6] to [9], wherein when the aforementioned fluorine-containing copolymer is molded into a test piece having a thickness of 4 mm, a ratio of a flexural modulus FM_{B} of the aforementioned test piece and a flexural modulus FM_{A} of a heated test piece obtained after heating the aforementioned test piece at 275° C. for 96 hours (FM_{A}/FM_{B}) is 1.2 or more.

[11] The method for producing a rectangular wire according to any one of [6] to [10], wherein a partial discharge inception voltage of the aforementioned insulating coating material is 800 Vrms or more.

[1A] A rectangular wire including: a rectangular conductor having a rectangular cross section in a direction perpendicular to the axial direction; and a film of an insulating coating material formed by extrusion molding that directly covers the entire circumferential direction of the aforementioned rectangular conductor, wherein a melt flow rate of the aforementioned insulating coating material at 372° C. is from 13 to 300 g/10 min, from 15 to 200 g/10 min, from 18 to 150 g/10 min, or from 20 to 60 g/10 min, an average thickness of the film of the aforementioned insulating coating material is from 10 to 1,000 μm, from 20 to 500 μm, or from 50 to 200 μm, an unbiased standard deviation of the thickness of the film of the aforementioned insulating coating material in the axial direction of the aforementioned rectangular wire is less than 0.06 mm, 0.03 mm or less, 0.01 mm or less, 0.001 mm or more and less than 0.06 mm, from 0.001 to 0.03 mm, or from 0.001 to 0.01 mm, the aforementioned insulating coating material contains a fluorine-containing copolymer having a unit based on tetrafluoroethylene and a unit based on perfluoroalkyl vinyl ether, and the aforementioned rectangular wire is such that the film of the aforementioned insulating coating material does not peel off from the aforementioned rectangular conductor in a winding test conforming to “JIS3216-3:2011 5.1.2 Rectangular Wire”.

[2A] The rectangular wire according to [1A], wherein a cross sectional area of the aforementioned rectangular conductor is 2.6 mm² or more, 3.0 mm² or more, from 2.6 to 15 mm², or from 3.0 to 15 mm².

[3A] The rectangular wire according to [1A] or [2A], wherein the aforementioned fluorine-containing copolymer has a —CH₂OH group, and an amount of the aforementioned —CH₂OH group is more than 30, 100 or more, 150 or more, more than 30 but not more than 5,000, from 100 to 2,000, or from 150 to 1,000, with respect to 1×10⁶ main chain carbon atoms of the aforementioned fluorine-containing copolymer.

[4A] The rectangular wire according to any one of [1A] to [3A], wherein when the aforementioned fluorine-containing copolymer is molded into a test piece having a thickness of 4 mm, a ratio of a flexural modulus FM_{B} of the aforementioned test piece and a flexural modulus FM_{A} of a heated test piece obtained after heating the aforementioned test piece at 275° C. for 96 hours (FM_{A}/FM_{B}) is 1.2 or more, 1.5 or more, 1.9 or more, from 1.2 to 10, from 1.5 to 5, or from 1.9 to 3.

[5A] The rectangular wire according to any one of [1A] to [4A], wherein a partial discharge inception voltage of the aforementioned insulating coating material is 800 Vrms or more, 1,000 Vrms or more, 1,100 Vrms or more, from 800 to 3,000 Vrms, from 1,000 to 2,500 Vrms, or from 1,100 to 2,000 Vrms.

[6A] A method for producing a rectangular wire including a rectangular conductor having a rectangular cross section in a direction perpendicular to the axial direction, and a film of an insulating coating material formed by extrusion molding that directly covers the entire circumferential direction of the aforementioned rectangular conductor, the method including: melting a fluorine-containing copolymer using an extruder equipped with a die; and extruding a melted fluorine-containing copolymer from the aforementioned die around the aforementioned rectangular conductor; thereby coating around the aforementioned rectangular conductor with the aforementioned melted fluorine-containing copolymer and forming the aforementioned insulating coating material; wherein a melt flow rate of the aforementioned insulating coating material at 372° C. is from 13 to 300 g/10 min, from 15 to 200 g/10 min, from 18 to 150 g/10 min, or from 20 to 60 g/10 min, an average thickness of the film of the aforementioned insulating coating material is from 10 to 1,000 μm, from 20 to 500 μm, or from 50 to 200 μm, an unbiased standard deviation of a thickness of the film of the aforementioned insulating coating material in the axial direction of the aforementioned rectangular wire is less than 0.06 mm, 0.03 mm or less, 0.01 mm or less, 0.001 mm or more and less than 0.06 mm, from 0.001 to 0.03 mm, or from 0.001 to 0.01 mm, the aforementioned fluorine-containing copolymer has a unit based on tetrafluoroethylene and a unit based on perfluoroalkyl vinyl ether, and the aforementioned rectangular wire is such that the film of the aforementioned insulating coating material does not peel off from the aforementioned rectangular conductor in a winding test conforming to “JIS3216-3:2011 5.1.2 Rectangular Wire”.

[7A] The method for producing a rectangular wire according to [6A], wherein a drawdown ratio DDR calculated by the following Formula 1 is 0.1 or more and less than 10.0, 0.5 or more and less than 10.0, from 0.5 to 5, or from 0.8 to 1.5.

$$DDR = ( {D}_{A} - {C}_{A} ) / ( FA - {C}_{A} ) \qquad Formula 1$$

In the aforementioned Formula 1, D_{A} is an opening area (mm²) of the aforementioned die, C_{A} is a cross sectional area (mm²) of the aforementioned rectangular conductor in a direction perpendicular to the axial direction, and FA is a cross sectional area (mm²) of the aforementioned rectangular wire in a direction perpendicular to the axial direction.

[8A] The method for producing a rectangular wire according to [6A] or [7A], wherein a cross sectional area of the aforementioned rectangular conductor is 2.6 mm² or more, 3.0 mm² or more, from 2.6 to 15 mm², or from 3.0 to 15 mm².

[9A] The method for producing a rectangular wire according to any one of [6A] to [8A], wherein the aforementioned fluorine-containing copolymer has a —CH₂OH group, and an amount of the aforementioned —CH₂OH group is more than 30, 100 or more, 150 or more, more than 30 but not more than 5,000, from 100 to 2,000, or from 150 to 1,000, with respect to 1×10⁶ main chain carbon atoms of the aforementioned fluorine-containing copolymer.

[10A] The method for producing a rectangular wire according to any one of [6A] to [9A], wherein when the aforementioned fluorine-containing copolymer is molded into a test piece having a thickness of 4 mm, a ratio of a flexural modulus FM_{B} of the aforementioned test piece and a flexural modulus FM_{A} of a heated test piece obtained after heating the aforementioned test piece at 275° C. for 96 hours (FM_{A}/FM_{B}) is 1.2 or more, 1.5 or more, 1.9 or more, from 1.2 to 10, from 1.5 to 5, or from 1.9 to 3.

[11A] The method for producing a rectangular wire according to any one of [6A] to [10A], wherein a partial discharge inception voltage of the aforementioned insulating coating material is 800 Vrms or more, 1,000 Vrms or more, 1,100 Vrms or more, from 800 to 3,000 Vrms, from 1,000 to 2,500 Vrms, or from 1,100 to 2,000 Vrms.

### Effects of the Invention

According to the present invention, it is possible to provide: a rectangular wire that is highly productive and exhibits excellent surface smoothness of the film of the insulating coating material and conformability of the film of the insulating coating material with respect to the rectangular conductor during bending deformation; as well as a production method thereof.

### DETAILED DESCRIPTION OF THE INVENTION

A melt flow rate is a melt mass flow rate prescribed in JIS K 7210-1:2014 (corresponding international standard: ISO 1133-1:2011). Hereinafter, the melt flow rate will also be referred to as MFR. The measurement conditions for MFR are a temperature of 372° C. and a load of 49 N.

The average thickness of the film of the insulating coating material is determined by collecting 5 m of the rectangular wire, measuring the thickness of the film of the insulating coating material on the long side of the rectangular cross section in a direction perpendicular to the axial direction every 100 mm, and taking the arithmetic average.

The unbiased standard deviation of the thickness of the film of the insulating coating material in the axial direction of the rectangular wire is determined from the measured values obtained by collecting 5 m of the rectangular wire, and measuring the thickness of the film of the insulating coating material on the long side of the rectangular cross section in a direction perpendicular to the axial direction every 100 mm.

The shear stress of the insulating coating material is a value measured using a known formula (for example, JIS K 7199:1999) corresponding to the die installed in the equipment used for extrusion molding. In the present specification, it is a value measured using a capillary die. More specifically, it is a value measured by a method described in paragraphs [0073] to [0075] and [0079] to [0081] in Japanese Unexamined Patent Application, First Publication No. 2015-086364.

The amount of —CH₂OH group in the fluorine-containing copolymer can be determined by infrared spectroscopy. More specifically, it can be determined by a method described in Examples.

The melting point of the fluorine-containing copolymer can be determined as a temperature corresponding to the maximum value of the melting peak measured by differential scanning calorimetry (DSC).

The flexural modulus and partial discharge inception voltage can be determined by a method described in Examples.

A unit of a polymer refers to a portion (polymerization unit) derived from a monomer formed by polymerization of the monomer. The unit may be a unit formed directly by a polymerization reaction, or may be a unit in which a part of the unit is converted into a different structure by processing the polymer. In the present specification, a unit based on a monomer is also referred to as a monomer unit.

### <<Rectangular Wire>>

It is provided with a rectangular conductor having a rectangular cross section in a direction perpendicular to the axial direction, and a film of an insulating coating material formed by extrusion molding that directly covers the entire circumferential direction of the aforementioned rectangular conductor. In the rectangular wire of the present embodiment, the film of the aforementioned insulating coating material does not peel off from the aforementioned rectangular conductor in a winding test conforming to “JIS3216-3:2011 5.1.2 Rectangular Wire”. In the above winding test, when the film of the aforementioned insulating coating material does not peel off from the aforementioned rectangular conductor, the surface smoothness of the film of the aforementioned insulating coating material and the conformability of the film of the insulating coating material with respect to the rectangular conductor during bending deformation are improved.

### <Rectangular Conductor>

The rectangular conductor is a core wire of the rectangular wire, and is a conductor with a rectangular cross section in a direction perpendicular to the axial direction.

The material of the rectangular conductor may be any known material for the core wire of an electric wire, and examples thereof include copper, tin, silver, gold, aluminum, and alloys thereof. Among these, copper is preferred from the viewpoint of ease of forming the rectangular conductor.

The thickness of the rectangular conductor is, for example, from 0.5 mm to 3.0 mm.

The width of the rectangular conductor is, for example, from 1.0 mm to 5.0 mm.

The thickness of the rectangular conductor is the short side of the rectangular cross section in the direction perpendicular to the axial direction. The width of the rectangular conductor is the long side of the rectangular cross section in the direction perpendicular to the axial direction.

The cross sectional area of the rectangular conductor is preferably 2.6 mm² or more, and more preferably 3.0 mm² or more. The upper limit of the cross sectional area of the rectangular conductor is not particularly limited, but it is, for example, 15 mm². The cross sectional area of the rectangular conductor is preferably from 2.6 to 15 mm², and more preferably from 3.0 to 15 mm².

The cross sectional area of the rectangular conductor is the area of the cross section in the direction perpendicular to the axial direction.

When the film of the insulating coating material exhibits low conformability with respect to the rectangular conductor during bending deformation, the larger the cross sectional area of the rectangular conductor, the more likely it is that during bending deformation of the rectangular wire, wrinkles form in the film of the insulating coating material or the film of the insulating coating material peel off from the rectangular conductor. Since the rectangular wire of the present embodiment exhibits excellent conformability of the film of the insulating coating material with respect to the rectangular conductor during bending deformation, the larger the cross sectional area of the rectangular conductor, the higher the usefulness.

### <Film of Insulating Coating Material>

The average thickness of the film of the insulating coating material is from 10 to 1,000 μm, preferably from 20 to 500 μm, and more preferably from 50 to 200 μm. When the average thickness of the film is equal to or more than the above lower limit value, the tracking resistance is excellent. When the average thickness of the film is equal to or less than the above upper limit value, the overall thickness of the rectangular wire can be made thinner, which allows the entire coil to save space when coiled, thereby contributing to the miniaturization of electrical equipment.

The unbiased standard deviation of the thickness of the film of the insulating coating material in the axial direction of the rectangular wire (hereinafter also simply referred to as “thickness variation”) is less than 0.06 mm, preferably 0.03 mm or less, and more preferably 0.01 mm or less. When the thickness variation of the film is less than (or not more than) the above upper limit value, crack resistance and tracking resistance during bending deformation are excellent.

The smaller the thickness variation of the film, the better, and it may be zero. From the viewpoints of ease of production and yield, the thickness variation of the film is preferably 0.001 mm or more.

The above lower limit values and the above upper limit values can be appropriately combined. Examples of the combination include 0.001 mm or more and less than 0.06 mm, from 0.001 to 0.03 mm, and from 0.001 to 0.01 mm, when the thickness variation of the film is not 0.

In order to make the thickness variation less than 0.06 mm, it is preferable to form the film of the insulating coating material by extrusion molding that directly covers the entire circumferential direction of the rectangular conductor. In the case of forming the film of the insulating coating material by other methods, such as powder coating, it is not preferred because the thickness variation is likely to be large. In particular, when forming the film of the insulating coating material by powder coating of a fluorine-containing resin, as compared to non-fluorine resins such as acrylic resins, epoxy resins, epoxy-acrylic resins, polyurethane resins, polyester resins, polyimide resins, polyamideimide resins, and polyesterimide resins, the variation is likely to be large due to the difficulty of adjusting the viscosity during melting.

The MFR of the insulating coating material at 372° C. is from 13 to 300 g/10 min, preferably from 15 to 200 g/10 min, more preferably from 18 to 150 g/10 min, and still more preferably from 20 to 60 g/10 min.

When the MFR of the insulating coating material at 372° C. is equal to or more than the above lower limit value, the surface smoothness of the film of the insulating coating material and the conformability of the film of the insulating coating material with respect to the rectangular conductor during bending deformation are improved. When the MFR of the insulating coating material at 372° C. is equal to or less than the above upper limit value, the strength of the film of the insulating coating material is increased.

The shear stress of the insulating coating material is preferably from 0.1 to 400 kPa, more preferably from 1 to 300 kPa, and still more preferably from 5 to 200 kPa. When the shear stress of the insulating coating material is equal to or more than the above lower limit value, the thickness uniformity of the coating of the insulating coating material is improved. When the shear stress of the insulating coating material is equal to or less than the above upper limit value, the adhesion to the conductor is improved.

The partial discharge inception voltage of the insulating coating material is preferably 800 Vrms or more, more preferably 1,000 Vrms or more, and still more preferably 1,100 Vrms or more. The upper limit value of the partial discharge inception voltage of the insulating coating material is not particularly limited, but may be, for example, 3,000 Vrms or less, 2,500 Vrms or less, or 2,000 Vrms or less. The partial discharge inception voltage of the insulating coating material is preferably from 800 to 3,000 Vrms, more preferably from 1,000 to 2,500 Vrms, and still more preferably from 1,100 to 2,000 Vrms.

If there are minute void-like defects and the like in the insulating coating material, the electric field concentrates at that part, and a weak discharge occurs. This discharge is a partial discharge. When the partial discharge inception voltage is equal to or higher than the above lower limit value, it means that there are few of the above defects. When the partial discharge inception voltage of the insulating coating material is equal to or higher than the above lower limit value, the adhesion of the insulating coating material with respect to the rectangular conductor is improved. As a result, the conformability of the film of the insulating coating material with respect to the rectangular conductor during bending deformation is improved.

The insulating coating material contains a fluorine-containing copolymer having a unit based on tetrafluoroethylene (hereinafter also referred to as “TFE”) and a unit based on perfluoroalkylvinyl ether (hereinafter also referred to as “PAVE”).

The insulating coating material may further contain other components in addition to the fluorine-containing copolymer as long as the characteristics thereof are not significantly impaired.

The amount of the fluorine-containing copolymer with respect to the total mass of the insulating coating material is preferably 50% by mass or more, more preferably 70% by mass or more, and may be 100% by mass.

### (Fluorine-Containing Copolymer)

The fluorine-containing copolymer has a TFE unit and a PAVE unit. The fluorine-containing copolymer may be a fluorine-containing copolymer composed of only the TFE unit and the PAVE unit, or a fluorine-containing copolymer having the TFE unit, PAVE unit, and other units.

Examples of PAVE include CF₂═CFORf1 (provided that Rf1 is a perfluoroalkyl group having 1 to 10 carbon atoms and which may contain an oxygen atom between the carbon atoms).

Specific examples of PAVE include CF₂═CFOCF₂CF₃, CF₂═CFOCF₂CF₂CF₃ (hereinafter also referred to as “PPVE”), CF₂═CFOCF₂CF₂CF₂CF₃, and CF₂═CFO(CF₂)₆F.

PPVE is preferred as PAVE.

Examples of other units include a unit u1 based on a monomer having fluorine other than the TFE unit and PAVE unit, and a unit u2 based on a monomer having a functional group (excluding monomers having fluorine).

As the monomer having fluorine for the unit u1, a fluorine-containing compound having one polymerizable carbon-carbon double bond is preferred. Examples thereof include a fluoroolefin (for example, vinyl fluoride, vinylidene fluoride, trifluoroethylene, hexafluoropropylene (hereinafter also referred to as “HFP”), chlorotrifluoroethylene, hexafluoroisobutylene, or the like, excluding TFE), CF₂═CFOR^{f2}SO₂X¹ (provided that R^{f2} is a perfluoroalkylene group having 1 to 10 carbon atoms which may contain an oxygen atom between the carbon atoms, and X¹ is a halogen atom or a hydroxyl group), CF₂═CFOR^{f3}CO₂X² (provided that R^{f3} is a perfluoroalkylene group having 1 to 10 carbon atoms which may contain an oxygen atom between the carbon atoms, and X² is a hydrogen atom or an alkyl group having 1 to 3 carbon atoms), CF₂═CF(CF₂)ₚOCF═CF₂ (provided that p is 1 or 2), fluoroalkylethylene (hereinafter also referred to as “FAE”), and a fluorine-containing monomer having a ring structure (for example, perfluoro (2,2-dimethyl-1,3-dioxole), 2,2,4-trifluoro-5-trifluoromethoxy-1,3-dioxole, perfluoro (2-methylene-4-methyl-1,3-dioxolane), or the like). One type of the monomer having fluorine may be used alone, or two or more types thereof may be used in combination.

As the monomer having fluorine for the unit u1, at least one selected from the group consisting of HFP and FAE is preferred from the viewpoint of excellent moldability of the fluorine-containing copolymer, and HFP is more preferred from the viewpoint of excellent electrical properties (dielectric constant, dielectric loss tangent) and heat resistance.

Examples of FAE include CH₂═CX³(CF₂)_{q}X⁴ (provided that X³ is a hydrogen atom or a fluorine atom, q is an integer from 2 to 10, and X⁴ is a hydrogen atom or a fluorine atom).

Specific examples of FAE include CH₂═CF(CF₂)₂F, CH₂═CF(CF₂)₃F, CH₂═CF(CF₂)₄F, CH₂═CF(CF₂)₅F, CH₂═CF(CF₂)₆F, CH₂═CF(CF₂)₂H, CH₂═CF(CF₂)₃H, CH₂═CF(CF₂)₄H, CH₂═CF(CF₂)₅H, CH₂═CF(CF₂)₆H, CH₂═CH(CF₂)₂F, CH₂═CH(CF₂)₃F, CH₂═CH(CF₂)₄F, CH₂═CH(CF₂)₅F, CH₂═CH(CF₂)₆F, CH₂═CH(CF₂)₂H, CH₂═CH(CF₂)₃H, CH₂═CH(CF₂)₄H, CH₂═CH(CF₂)₅H, and CH₂═CH(CF₂)₆H.

As FAE, CH₂═CH(CF₂)_{q1}X⁴ (provided that q1 is from 2 to 6, and preferably from 2 to 4) is preferred, CH₂═CH(CF₂)₂F, CH₂═CH(CF₂)₃F, CH₂═CH(CF₂)₄F, CH₂═CF(CF₂)₃H and CH₂═CF(CF₂)₄H are more preferred, and CH₂═CH(CF₂)₄F and CH₂═CH(CF₂)₂F are particularly preferred.

Examples of the monomer having a functional group for the unit u2 include monomers having a carboxy group (such as maleic acid, itaconic acid, citraconic acid, and undecylenic acid); monomers having an acid anhydride group (such as itaconic anhydride (hereinafter also referred to as “IAH”), citraconic anhydride (hereinafter also referred to as “CAH”), 5-norbornene-2,3-dicarboxylic anhydride (hereinafter also referred to as “NAH”), and maleic anhydride), and monomers having a hydroxyl group and an epoxy group (such as hydroxybutyl vinyl ether and glycidyl vinyl ether). One type of the monomer having a functional group may be used alone, or two or more types thereof may be used in combination.

As the monomer having a functional group for the unit u2, a monomer having an acid anhydride group is preferred, and one or more selected from the group consisting of IAH, CAH and NAH are preferred, IAH or NAH is more preferred, and NAH is still more preferred. By using one or more selected from the group consisting of IAH, CAH and NAH, a fluorine-containing copolymer having an acid anhydride group can be easily produced without using a special polymerization method (see Japanese Unexamined Patent Application, First Publication No. Hei 11-193312) that is required when maleic anhydride is used.

Preferred amounts and ratios of each unit in the fluorine-containing copolymer are as follows.

The amount of the TFE unit with respect to the total amount of the structural unit of the fluorine-containing copolymer is preferably from 90.0 to 99.9 mol %, more preferably from 95.0 to 99.5 mol %, and still more preferably from 96 to 99.0 mol %.

When the fluorine-containing copolymer contains at least one of the units u1 and u2, the amount of the TFE unit with respect to the total amount of the structural unit of the fluorine-containing copolymer is preferably from 79 to 99.85 mol %, more preferably from 89.5 to 99.4 mol %, and still more preferably from 90.5 to 98.9 mol %.

The amount of the PAVE unit with respect to the total amount of the structural unit of the fluorine-containing copolymer is preferably from 0.1 to 10.0 mol %, more preferably from 0.5 to 5.0 mol %, and still more preferably from 1.0 to 4.0 mol %.

When the fluorine-containing copolymer contains at least one of the units u1 and u2, the amount of the PAVE unit with respect to the total amount of the structural unit of the fluorine-containing copolymer is preferably from 0.1 to 10.0 mol %, more preferably from 0.5 to 5.0 mol %, and still more preferably from 1.0 to 4.0 mol %.

The total amount of the TFE unit and the PAVE unit with respect to the total amount of the structural unit of the fluorine-containing copolymer is preferably from 80 to 100 mol %, more preferably from 85 to 100 mol %, and still more preferably from 90 to 100 mol %.

In the fluorine-containing copolymer, a molar ratio of PAVE unit/TFE unit is preferably from 0.1/99.9 to 10.0/90.0, more preferably from 0.5/99.5 to 5.0/95.0, and still more preferably from 1.0/99.0 to 4.0/96.0.

When the fluorine-containing copolymer contains the unit u1, the amount of the unit u1 with respect to the total amount of the structural unit of the fluorine-containing copolymer is preferably from 0.5 to 15 mol %, and more preferably from 1 to 10 mol %.

When the fluorine-containing copolymer contains the unit u2, the amount of the unit u2 with respect to the total amount of the structural unit of the fluorine-containing copolymer is preferably from 0.05 to 1 mol %, and more preferably from 0.1 to 0.5 mol %.

When the amount and ratio of each unit are within the above ranges, the surface smoothness of the film of the insulating coating material and the conformability of the film of the insulating coating material with respect to the rectangular conductor during bending deformation are improved in the obtained rectangular wire.

The ratio of each unit can be calculated by melt NMR analysis, fluorine amount analysis, infrared absorption spectrum analysis, or the like of the fluorine-containing copolymer.

The fluorine-containing copolymer may contain a unit based on a dicarboxylic acid (itaconic acid, citraconic acid, 5-norbornene-2,3-dicarboxylic acid, maleic acid, or the like) corresponding to the acid anhydride group-containing cyclic hydrocarbon monomer as a result of hydrolysis of a portion of the acid anhydride group in the unit u2. When the above unit based on a dicarboxylic acid is contained, this unit is regarded as a unit u2.

Preferred specific examples of the fluorine-containing copolymer include a TFE/PAVE copolymer and a TFE/PAVE/NAH copolymer.

The MFR of the fluorine-containing copolymer at 372° C. is preferably from 13 to 300 g/10 min, more preferably from 15 to 200 g/10 min, still more preferably from 18 to 150 g/10 min, and particularly preferably from 18 to 80 g/10 min.

The fluorine-containing copolymer preferably has a —CH₂OH group. The amount of the —CH₂OH group is preferably more than 30, more preferably 100 or more, and still more preferably 150 or more, with respect to 1×10⁶ main chain carbon atoms of the fluorine-containing copolymer. The upper limit value of the amount of the —CH₂OH group is not particularly limited, but may be, for example, 5,000 or less, 2,000 or less, or 1,000 or less. The amount of the —CH₂OH group is preferably more than 30 and not more than 5,000, more preferably from 100 to 2,000, and still more preferably from 150 to 1,000, with respect to 1×10⁶ main chain carbon atoms of the fluorine-containing copolymer.

When the amount of the —CH₂OH group in the fluorine-containing copolymer is equal to or more than the above lower limit value, the —CH₂OH group bonds with an atom on the surface of the rectangular conductor, thereby improving the adhesion of the insulating coating material with respect to the rectangular conductor. As a result, the conformability of the film of the insulating coating material with respect to the rectangular conductor during bending deformation is improved.

The —CH₂OH group of the fluorine-containing copolymer is, for example, a —CH₂OH group derived from a chain transfer agent or polymerization initiator used in producing the fluorine-containing copolymer. For example, when an alcohol is used as a chain transfer agent, or when a peroxide having a —CH₂OH group is used as a polymerization initiator, a —CH₂OH group is introduced into the main chain terminal of the copolymer. Further, by polymerizing a monomer having a —CH₂OH group, a —CH₂OH group is introduced into the side chain terminal of the fluorine-containing copolymer.

It should be noted that the amount of the —CH₂OH group can be reduced by subjecting a fluorine-containing copolymer having a —CH₂OH group to fluorination treatment. Further, the amount of the —CH₂OH group can also be controlled by controlling the type and amount of the chain transfer agent, polymerization initiator, and monomer, and the reaction conditions.

The melting point of the fluorine-containing copolymer is preferably from 260 to 350° C., more preferably from 280 to 340° C., and still more preferably from 290 to 330° C.

When the fluorine-containing copolymer is molded into a test piece having a thickness of 4 mm, a ratio of a flexural modulus FM_{A} (MPa) of the heated test piece obtained after heating the aforementioned test piece at 275° C. for 96 hours with respect to a flexural modulus FM_{B} (MPa) of the aforementioned test piece (FM_{A}/FM_{B}) is preferably 1.2 or more, more preferably 1.5 or more, and still more preferably 1.9 or more. The upper limit value of FM_{A}/FM_{B} is not particularly limited, but may be, for example, 10 or less, 5 or less, or 3 or less. FM_{A}/FM_{B} is preferably from 1.2 to 10, more preferably from 1.5 to 5, and still more preferably from 1.9 to 3.

When FM_{A}/FM_{B} is equal to or more than the above lower limit value, the adhesion of the insulating coating material with respect to the rectangular conductor is improved. As a result, the conformability of the film of the insulating coating material with respect to the rectangular conductor during bending deformation is improved.

The FM_{B} is preferably from 200 to 900 MPa, more preferably from 300 to 800 MPa, and still more preferably from 400 to 700 MPa.

The FM_{A} is preferably from 710 to 3,000 MPa, more preferably from 750 to 2,500 MPa, and still more preferably from 900 to 2,000 MPa.

The fluorine-containing copolymer may be produced by a known production method, or a commercially available product may be used. Examples of known production methods include methods described in International Patent Publication No. 2015/182702, International Patent Publication No. 2016/006644, and International Patent Publication No. 2016/017801.

### <Other Components>

Examples of other components include fluorine-containing polymers other than fluorine-containing copolymers having a TFE unit and a PAVE unit, fluorine-free polymers, fillers, pigments, and other additives.

As specific examples of fillers, resins and inorganic fillers are preferred. Examples of the resins include fibrous resins such as aramid fibers and liquid crystal polyester fibers, and examples of powdered resins include powder resins of polytetrafluoroethylene and the like. Examples of the inorganic fillers include fibrous fillers such as glass fibers, carbon fibers, boron fibers, and stainless steel microfibers; and powdered fillers such as talc, mica, graphite, molybdenum disulfide, calcium carbonate, silica, silica alumina, alumina, and titanium dioxide.

Other examples include hydrotalcites and metal oxides, such as zinc oxide, magnesium oxide, titanium oxide, lead oxide, and copper oxide.

Further, metal powders can also be used. Examples thereof include powders of stainless steel, iron-based materials, titanium, copper, and nickel.

One type of filler may be used alone, or two or more types thereof may be used in combination.

Examples of the pigments include color pigments such as organic pigments and inorganic pigments. Specific examples thereof include carbon black (black pigment), iron oxide (red pigment), aluminum cobalt oxide (blue pigment), copper phthalocyanine (blue pigment, green pigment), perylene (red pigment), and bismuth vanadate (yellow pigment).

One type of these other components may be used alone, or two or more types thereof may be used in combination.

### <Method for Producing Rectangular Wire>

The rectangular wire described above can be produced by a method in which a fluorine-containing copolymer is melted using an extruder equipped with a die; and a melted fluorine-containing copolymer is extruded from the aforementioned die around a rectangular conductor; thereby coating around the aforementioned rectangular conductor with the aforementioned melted fluorine-containing copolymer and forming the aforementioned insulating coating material. In addition to the fluorine-containing copolymer, the other components described above may be added to the extruder.

Examples of the extruder include a twin screw extruder and a single screw extruder, and a twin screw extruder is preferred.

The opening surface of the die has a rectangular shape.

The cylinder temperature and die temperature of the extruder are set in accordance with the type of the fluorine-containing copolymer. The cylinder temperature of the extruder is preferably from 50 to 450° C., more preferably from 80 to 440° C., and still more preferably from 90 to 430° C. The die temperature is preferably from 100 to 420° C., more preferably from 120 to 400° C., and still more preferably from 150 to 380° C. When the cylinder temperature and die temperature of the extruder are equal to or higher than the above lower limit values, the compatibility of the materials by kneading is favorable. When the cylinder temperature and die temperature of the extruder are equal to or lower than the above upper limit values, deterioration of the fluorine-containing copolymer due to heat is easily suppressed.

The residence time in the extruder is preferably 10 seconds or more and 30 minutes or less.

The screw rotation speed of the extruder is preferably from 0.5 to 100 rpm.

The rectangular conductor is preferably preheated. The temperature of the preheated rectangular conductor is preferably from 50 to 400° C., and more preferably from 80 to 250° C. There are no particular limitations on the preheating method, but examples thereof include optical heating, hot air heating, radiation heating, gas burner heating, and induction heating.

### (Drawdown Ratio)

In the method for producing a rectangular wire of the present embodiment, a drawdown ratio (hereinafter also referred to as “DDR”) calculated by the following Formula 1 is preferably 0.1 or more and less than 10.0, more preferably 0.5 or more and less than 10.0, still more preferably from 0.5 to 5, and particularly preferably from 0.8 to 1.5

When the DDR is equal to or more than the above lower limit value, a rectangular wire excellent in surface smoothness of the film of the insulating coating material is likely to be obtained. When the DDR is less than (or not more than) the above upper limit value, a rectangular wire excellent in surface smoothness of the film of the insulating coating material and conformability of the film of the insulating coating material with respect to the rectangular conductor during bending deformation is likely to be obtained.

$$DDR = ( {D}_{A} - {C}_{A} ) / ( FA - {C}_{A} ) \qquad Formula 1$$

In the above Formula 1, D_{A} is an opening area (mm²) of the die, C_{A} is a cross sectional area (mm²) of the rectangular conductor in a direction perpendicular to the axial direction, and F_{A} is a cross sectional area (mm²) of the rectangular wire in a direction perpendicular to the axial direction.

D_{A} can be obtained from the following Formula 2.

$${D}_{A} = {D}_{L} \times {D}_{S} \qquad Formula 2$$

In the above Formula 2, D_{L} is an internal dimension (mm) of the long side of the rectangular opening surface of the die, and D_{S} is an internal dimension (mm) of the short side of the rectangular opening surface of the die.

C_{A} can be obtained from the following Formula 3.

$${C}_{A} = {C}_{L} \times {C}_{S} \qquad Formula 3$$

In the above Formula 3, C_{L} is a long side (mm) of the rectangular cross section of the rectangular conductor in a direction perpendicular to the axial direction, and C_{S} is a short side (mm) of the rectangular cross section of the rectangular conductor in a direction perpendicular to the axial direction.

F_{A} can be obtained from the following Formula 4.

$${F}_{A} = {F}_{L} \times {F}_{S} \qquad Formula 4$$

In the above Formula 4, F_{L} is a long side (mm) of the rectangular cross section of the rectangular wire in a direction perpendicular to the axial direction, and F_{S} is a short side (mm) of the rectangular cross section of the rectangular wire in a direction perpendicular to the axial direction.

In the present embodiment, it is preferable to adopt the so-called pressure molding method, in which the insulating coating material is formed under pressure. By adopting the pressure molding method, as compared to the conventional tube molding method, the DDR is more likely to be less than (or not more than) the above upper limit value, and as a result, a rectangular wire excellent in surface smoothness of the film of the insulating coating material and conformability of the film of the insulating coating material with respect to the rectangular conductor during bending deformation is likely to be obtained.

### (Applications)

The rectangular wire of the present invention can be suitably used in, for example, isolation amplifiers, isolation transformers, automobile alternators, hybrid vehicles, electric ships, electric aircraft, electric motors for electric vertical takeoff and landing aircraft, and the like. In addition, it can also be used as various electric wires (wrapped electric wires, electric wires for automobiles, electric wires for robots) and coil windings (magnet wires).

### Examples

The present invention will be described in more detail below with reference to Examples, but the present invention is not limited to these Examples. In the following Cases, Cases 1 and 3 are Examples of the present invention, and Cases 2, 4, 5, and 6 are Comparative Examples.

### <Evaluation Method>

### (MFR of Fluorine-Containing Copolymer and Insulating Coating Material)

After preheating pellets of a fluorine-containing copolymer or an insulating coating material for 5 minutes, the MFR at 49 N was measured in accordance with JIS K 7210-1:2014. The measurement was conducted at 372° C. In Table 1, this is referred to as MFR.

### (Shear Stress of Insulating Coating Material)

The measurement was conducted in accordance with JIS K 7199:1999. More specifically, the measurement was conducted by a method described in paragraphs [0073] to [0075] and [0079] to [0081] in Japanese Unexamined Patent Application, First Publication No. 2015-086364 (using a capillary die). A film of the insulating coating material was separated from a rectangular conductor of a rectangular wire and used as a measurement sample. The shear rate was set to 122 sec⁻¹, and the measurement temperature was set to 350° C.

### (Flexural Modulus of Fluorine-Containing Copolymer)

Pellets of the fluorine-containing copolymer were pre-dried for 3 hours under heating at 200° C. Subsequently, a resin composition was injection molded using an injection molding machine (ROBOSHOT α-50, manufactured by Fanuc Corporation) under the conditions of a cylinder temperature of 380° C. and a die temperature of 170° C. to obtain an injection molded article having a thickness of 4 mm. A test piece was heated in an air atmosphere at 275° C. for 96 hours to obtain a heated injection molded article.

The injection molded article and the heated injection molded article were cut out into pieces with a length of 80 mm and a width of 10 mm and used as the test piece and the heated test piece, respectively. With respect to the test piece and the heated test piece, the flexural modulus was measured by using TENSILON (RTF-1350, manufactured by A & D Co., Ltd.) at a load cell rating of 10 kN, a distance between fulcrums of 64 mm and a rate of 2 mm/min in accordance with JIS K7171 (corresponding international standard: ISO 527-1:2012). In Table 1, the flexural modulus of the test piece is indicated as FM_{B}, and the flexural modulus of the heated test piece is indicated as FM_{A}.

### (Amount of —CH₂OH Group in Fluorine-Containing Copolymer)

Pellets of the fluorine-containing copolymer were molded by cold pressing to produce a film with a thickness of 0.25 to 0.30 mm. This film was scanned and analyzed 40 times using a Fourier transform infrared spectrophotometer (FT-IR (Spectrum One, manufactured by PerkinElmer, Inc.)) to obtain an infrared absorption spectrum 1. The same operation was also performed on pellets of a completely fluorinated fluorine-containing copolymer that does not have a —CH₂OH group (however, the thickness of the film was the same) to obtain an infrared absorption spectrum 2. The infrared absorption spectrum 2 was subtracted from the infrared absorption spectrum 1 to obtain a difference spectrum. The amount of the —CH₂OH group with respect to 1×10⁶ main chain carbon atoms of the fluorine-containing copolymer was obtained from the peak (absorbance) at 3648 cm−1 in this difference spectrum using the following Formula 5. The peak at 3648 cm−1 is a peak confirmed in a model compound C₇H₁₅CH₂OH having a —CH₂OH group. It should be noted that the molar absorption coefficient of the —CH₂OH group is 104 (absorbance/cm/mol). In Table 1, the amount of the —CH₂OH group in the fluorine-containing copolymer is expressed as a —CH₂OH group. Further, the denominator of the unit [groups] is the number of carbon atoms in the main chain of the fluorine-containing copolymer, 1×10⁶, but this is omitted in Table 1.

$$N = I \times A \times t \qquad Formula 5$$

In the above Formula 5, I is absorbance, A is a correction coefficient, which is 2236 in the case of —CH₂OH group, and t is the thickness of the film (mm).

### (Partial Discharge Inception Voltage of Insulating Coating Material)

The film of the insulating coating material was cut out from the rectangular conductor of the rectangular wire and press molded (350° C., preheated for 5 minutes, pressurized for 2 minutes) to obtain a measurement sample of 130 mm×130 mm×0.12 mm (thickness). Using the obtained measurement sample, the partial discharge inception voltage of the insulating coating material was measured under the following measurement conditions (low frequency method). A voltage when a discharge intensity of 10 pC was detected was obtained as the partial discharge inception voltage. It should be noted that the measurement was performed on five measurement samples, and an average of these was taken as the partial discharge inception voltage. In Table 1, the partial discharge inception voltage is indicated as PDIV.

### [Measurement Conditions]

Measuring device: Partial Discharge Detector A-006, manufactured by Fujikura Dia Cable Ltd.

Electrode: electrodes conforming to JIS C 2110-1 were used.

Test voltage: set up to a maximum of 20 kVrms (50 Hz), and reduced after detecting a discharge intensity of 100 pC.

Voltage increase/decrease rate: 100 V/sec.

Other conditions: in air, temperature: 18 degrees, relative humidity: 30%.

### (Average Thickness and Thickness Variation of Film)

5 m of rectangular wire was collected, and the thickness of the film of the insulating coating material on the long side of the rectangular cross section in a direction perpendicular to the axial direction (only the side that comes into contact with the upper inner surface of the die during molding) was measured every 100 mm.

An arithmetic mean value of the measured values (mm) was taken as the average thickness.

An unbiased standard deviation of the measured values (mm) was taken as the thickness variation.

### (Winding Test)

The rectangular wire was evaluated by a winding test in accordance with “JIS3216-3:2011 5.1.2 Rectangular Wire”. The cross section of the rectangular wire was visually confirmed and evaluated in accordance with the following criteria. In Table 1, this is indicated as a winding test.

A: no peeling off of the film of the insulating coating material from the rectangular conductor.

B: peeling off of the film of the insulating coating material from the rectangular conductor.

### (Conformability)

The rectangular wire was bent and deformed in the edgewise direction and flatwise direction, respectively. The deformation angle was set to 90±10° Thereafter, the surface of the film of the insulating coating material at the bent and deformed portion and the cross section of the rectangular wire were visually observed, and the conformability was evaluated in accordance with the following criteria.

A: no wrinkles were generated on the surface of the film of the insulating coating material during the above bending deformation, and the film of the insulating coating material did not peel off from the rectangular conductor.

B: wrinkles were generated on the surface of the film of the insulating coating material during the above bending deformation, or the film of the insulating coating material peeled off from the rectangular conductor.

### (Surface Smoothness)

The surface roughness (Ra) of the rectangular wire was measured using a digital microscope (HRX-1, manufactured by Hirox Co., Ltd.). The measurement was performed at a magnification of 80× and a length of 4 mm.

A: surface roughness of 45 μm or less

B: surface roughness of more than 45 μm

### (Materials Used)

Fluorine-containing copolymer 1: a fluorine-containing copolymer with a molar ratio of TFE unit: PPVE unit=98.0:2.0 (melting point: 310° C.)

Fluorine-containing copolymer 2: a fluorine-containing copolymer with a molar ratio of TFE unit: PPVE unit: NAH unit=97.9:2.0:0.1 (melting point: 300° C., specific gravity: 2.13)

Fluorine-containing copolymer 3: a fluorine-containing copolymer with a molar ratio of TFE unit: PPVE unit=98.0:2.0 (melting point: 312° C.)

It should be noted that the fluorine-containing copolymer 3 is a fluorine-containing copolymer in which the amount of the —CH₂OH group with respect to 1×10⁶ main chain carbon atoms of the fluorine-containing copolymer has been controlled to 0 by fluorination treatment.

### (Case 1)

A rectangular wire was produced by wire extrusion molding using the fluorine-containing copolymer 1 under the following conditions. The DDR was set to 1. In the wire extrusion molding process, the so-called pressure molding method in which the insulating coating material was formed under pressure was employed.

Die temperature: 400° C.

Cylinder temperature: 280 to 380° C.

Rectangular conductor: a rectangular copper wire with a thickness of 1.5 mm and a width of 2.3 mm.

Preheating temperature of rectangular conductor: 180° C.

Coating thickness (set value): 0.18 mm.

### (Case 2)

A rectangular wire was produced in the same manner as in Case 1, with the exception that the DDR was set to 15. However, in the wire extrusion molding process, the so-called tube molding method in which the insulating coating material was formed substantially under normal pressure was employed.

### (Case 3)

A rectangular wire was produced by wire extrusion molding using the fluorine-containing copolymer 2 under the following conditions. The DDR was set to 1. In the wire extrusion molding process, the so-called pressure molding method in which the insulating coating material was formed under pressure was employed.

Die temperature: 390° C.

Cylinder temperature: 280 to 390° C.

Rectangular conductor: a rectangular copper wire with a thickness of 1.5 mm and a width of 2.3 mm.

Preheating temperature of rectangular conductor: 180° C.

Coating thickness (set value): 0.18 mm.

### (Case 4)

A rectangular wire was produced in the same manner as in Case 3, with the exception that the DDR was set to 15. However, in the wire extrusion molding process, the so-called tube molding method in which the insulating coating material was formed under substantially normal pressure was employed.

### (Case 5)

A rectangular wire was produced by wire extrusion molding using the fluorine-containing copolymer 3 under the following conditions. The DDR was set to 1. In the wire extrusion molding process, the so-called pressure molding method in which the insulating coating material was formed under pressure was employed.

Die temperature: 380° C.

Cylinder temperature: 280 to 380° C.

Rectangular conductor: a rectangular copper wire with a thickness of 1.5 mm and a width of 2.3 mm.

Preheating temperature of rectangular conductor: 180° C.

Coating thickness (set value): 0.18 mm.

### (Case 6)

A rectangular wire was produced in the same manner as in Case 5, with the exception that the DDR was set to 15. However, in the wire extrusion molding process, the so-called tube molding method in which the insulating coating material was formed under substantially normal pressure was employed.

The insulating coating material and rectangular wire of each example were evaluated as described above. The results are shown in Table 1.

TABLE 1

| | | Case 1 | Case 2 | Case 3 | Case 4 | Case 5 | Case 6 |
|---|---|---|---|---|---|---|---|
| Fluorine- | Type | 1 | 1 | 2 | 2 | 3 | 3 |
| containing | MFR [g/10 | 32 | 32 | 18 | 18 | 12 | 12 |
| copolymer | min] | | | | | | |
| | FM_{B} [MPa] | 574 | 574 | 697 | 697 | 613 | 613 |
| | FM_{A} [MPa] | 1,093 | 1,093 | 1,585 | 1,585 | 701 | 701 |
| | FM_{A}/FM_{B} | 1.9 | 1.9 | 2.3 | 2.3 | 1.1 | 1.1 |
| | Amount of - | 168 | 168 | 303 | 303 | 0 | 0 |
| | CH₂OH group | | | | | | |
| | [groups] | | | | | | |
| Insulating | MFR [g/10 | 33 | 33 | 20 | 20 | 12 | 12 |
| coating | min] | | | | | | |
| material | PDIV [Vrms] | 1,150 | <500 | 1,110 | <500 | <500 | <500 |
| | Shear stress | 121 | 121 | 151 | 151 | 147 | 147 |
| | [kPa] | | | | | | |
| Film | Average | 0.18 | 0.1 to 0.3 | 0.18 | 0.1 to 0.3 | 0.1 to 0.3 | 0.1 to 0.3 |
| | thickness | | | | | | |
| | [mm] | | | | | | |
| | Thickness | <0.02 | >0.05 | <0.02 | >0.05 | <0.02 | >0.05 |
| | variation [mm] | | | | | | |
| Rectangular | Winding test | A | B | A | B | B | B |
| wire | Conformability | A | B | A | B | B | B |
| | Surface | A | B | A | B | B | B |
| | smoothness | | | | | | |
| | Surface | <15 | — | <15 | — | — | — |
| | roughness Ra | | | | | | |
| | [μm] | | | | | | |

Cases 1 and 3 were excellent in surface smoothness of the film of the insulating coating material and in conformability of the film of the insulating coating material with respect to the rectangular conductor during bending deformation.

On the other hand, Cases 2, 4, and 6 in which the DDR was set to 15 were inferior in surface smoothness of the film of the insulating coating material and in conformability of the film of the insulating coating material with respect to the rectangular conductor during bending deformation.

Case 5 in which the MFR of the insulating coating material at 372° C. was less than 13 g/10 min was inferior in surface smoothness of the film of the insulating coating material and in conformability of the film of the insulating coating material with respect to the rectangular conductor during bending deformation, even when the DDR was set to 1.

What is claimed is:

1. A rectangular wire comprising:
a rectangular conductor having a rectangular cross section in a direction perpendicular to the axial direction; and
a film of an insulating coating material formed by extrusion molding that directly covers the entire circumferential direction of said rectangular conductor,
wherein: a melt flow rate of said insulating coating material at 372° C. is from 13 to 300 g/10 min;
an average thickness of the film of said insulating coating material is from 10 to 1,000 μm;
an unbiased standard deviation of a thickness of the film of said insulating coating material in the axial direction of said rectangular wire is less than 0.06 mm;
said insulating coating material contains a fluorine-containing copolymer having a unit based on tetrafluoroethylene and a unit based on perfluoroalkyl vinyl ether; and
said rectangular wire is such that the film of said insulating coating material does not peel off from said rectangular conductor in a winding test conforming to “JIS3216-3:2011 5.1.2 Rectangular Wire”.

2. The rectangular wire according to claim 1, wherein a cross sectional area of said rectangular conductor is 2.6 mm² or more.

3. The rectangular wire according to claim 1,
wherein said fluorine-containing copolymer has a —CH₂OH group, and
an amount of said —CH₂OH group is more than 30 with respect to 1×10⁶ main chain carbon atoms of said fluorine-containing copolymer.

4. The rectangular wire according to claim 1,
wherein when said fluorine-containing copolymer is molded into a test piece having a thickness of 4 mm, a ratio of a flexural modulus FM_{B} of said test piece and a flexural modulus FM_{A} of a heated test piece obtained after heating said test piece at 275° C. for 96 hours (FM_{A}/FM_{B}) is 1.2 or more.

5. The rectangular wire according to claim 1, wherein a partial discharge inception voltage of said insulating coating material is 800 Vrms or more.

6. A method for producing a rectangular wire including a rectangular conductor having a rectangular cross section in a direction perpendicular to the axial direction, and a film of an insulating coating material formed by extrusion molding that directly covers the entire circumferential direction of said rectangular conductor,
the method comprising:
melting a fluorine-containing copolymer using an extruder equipped with a die; and
extruding a melted fluorine-containing copolymer from said die around said rectangular conductor;
thereby coating around said rectangular conductor with said melted fluorine-containing copolymer and forming said insulating coating material;
wherein: a melt flow rate of said insulating coating material at 372° C. is from 13 to 300 g/10 min;
an average thickness of the film of said insulating coating material is from 10 to 1,000 μm;
an unbiased standard deviation of the thickness of the film of said insulating coating material in the axial direction of said rectangular wire is less than 0.06 mm;
said fluorine-containing copolymer comprises a unit based on tetrafluoroethylene and a unit based on perfluoroalkyl vinyl ether; and
said rectangular wire is such that the film of said insulating coating material does not peel off from said rectangular conductor in a winding test conforming to “JIS3216-3:2011 5.1.2 Rectangular Wire”.

7. The method for producing a rectangular wire according to claim 6,
wherein a drawdown ratio DDR calculated by the following Formula 1 is 0.5 or more and less than 10.0,
$$DDR = ( {D}_{A} - {C}_{A} ) / ( {F}_{A} - {C}_{A} ) \qquad Formula 1$$
wherein D_{A} is an opening area (mm²) of said die, C_{A} is a cross sectional area (mm²) of said rectangular conductor in a direction perpendicular to the axial direction, and F_{A} is a cross sectional area (mm²) of said rectangular wire in a direction perpendicular to the axial direction.

8. The method for producing a rectangular wire according to claim 6, wherein a cross sectional area of said rectangular conductor is 2.6 mm² or more.

9. The method for producing a rectangular wire according to claim 6,
wherein said fluorine-containing copolymer comprises a —CH₂OH group, and
an amount of said —CH₂OH group is more than 30 with respect to 1×10⁶ main chain carbon atoms of said fluorine-containing copolymer.

10. The method for producing a rectangular wire according to claim 6,
wherein when said fluorine-containing copolymer is molded into a test piece having a thickness of 4 mm, a ratio of a flexural modulus FM_{B} of said test piece and a flexural modulus FM_{A} of a heated test piece obtained after heating said test piece at 275° C. for 96 hours (FM_{A}/FM_{B}) is 1.2 or more.

11. The method for producing a rectangular wire according to claim 6,
wherein a partial discharge inception voltage of said insulating coating material is 800 Vrms or more.
